(19) United States
(12) Patent Application Publication
(10) Pub. No.: US 2006/0256421 A1
(43) Pub. Date: Nov. 16, 2006

(54) Electrophoretic display device

(75) Inventors: Volker Schoellmann, Eindhoven (NL); Guofu Zhou, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/554,011

(22) PCT Filed: Apr. 22, 2004
(86) PCT No.: PCT/IB04/50492

§ 371 Date: Oct. 21, 2005

(30) Foreign Application Priority Data
Apr. 24, 2003 (EP) 031011331

(51) Int. Cl. G02B 26/00

(52) U.S. Cl. 359/296

(57) ABSTRACT

The electrophoretic display device has a plurality of pixels with an electrophoretic medium (7). Each pixel is divided into a first and a second sub-pixel (1; 2). Each pixel is provided with a common electrode (3) extending over the first and second subpixel. The first sub-pixel is provided with a first sub-pixel electrode (11) and the second sub-pixel is provided with a second sub-pixel electrode (12). Preferably, the first sub-pixel is provided with a first light absorbing layer (21) and the second sub-pixel is provided with a second light absorbing layer (22), while the first and second light absorbing layer are provided at opposite sites of the pixels. Preferably, the electrophoretic medium comprises micro-encapsulated electrophoretic ink. Preferably, the ink comprises two types of particles (31; 32) always staying in the optical path of the pixels. According to the invention a doublesided display device is provided with a single electrophoretic medium.

The invention relates to an electrophoretic display device displaying to two different directions.

Electrophoretic display devices are based on light absorbing and/or reflecting particles moving under the influence of an electric field between electrodes provided on opposite substrates. The charged electrophoretic particles usually are colored particles or black and white particles. With these display devices, dark (colored) characters can be imaged on a light (colored) background, and vice versa. Electrophoretic display devices are notably used in display devices taking over the function of paper and are often referred to as “electronic paper” or “paper white” applications (electronic newspapers, electronic diaries).

For mobile display applications, electrophoretic display devices offer an advantageous performance including relatively low power consumption due to long-term image stability, relatively high white state reflectivity and contrast, and “paper-like” optics enhancing readability and legibility. The optical performance of these reflective display devices makes them relatively insensitive to ambient lighting intensity and direction. Electrophoretic display devices provide a viewing angle which is practically as wide as that of normal paper. The performance is such that supplemental illumination solutions such as front lights are not required for many devices.

Optical materials based on microencapsulated electrophoretic ink have been successfully integrated with traditional a-Si thin-film transistors (TFTs), a-Si TFTs built on conformable steel foils or organic TFTs. Facile mechanical integration of the material to active matrices leads to substantial simplifications in their cell assembly process compared to that of liquid crystal display (LCD) devices. In monochrome electrophoretic displays devices, for example, a flexible plastic front sheet coated with indium tin oxide (ITO) and the electrophoretic medium is laminated directly to a thin-film transistor backplane. After lamination, an edge seal is applied around the perimeter of the display device. In principle, no polarizer films, alignment layers, rubbing processes, or spacers are required.

The invention has for its object to provide an electrophoretic display device displaying to two different directions. According to the invention, an electrophoretic display device of the kind mentioned in the opening paragraph for this purpose comprises:

a plurality of pixels with an electrophoretic medium,

each pixel being divided into a first and a second sub-pixel,

each pixel being provided with a common electrode extending over the first and second sub-pixel,

the first sub-pixel being provided with a first sub-pixel electrode and the second sub-pixel being provided with a second sub-pixel electrode.

Due to the provision of separate electrodes for each sub-pixel, the state of the sub-pixel can be set independently. According to the invention a double-sided display device is provided with a single electrophoretic medium.

A preferred embodiment of the electrophoretic display device according to the invention is characterized in that the first sub-pixel is provided with a first light absorbing layer and the second sub-pixel is provided with a second light absorbing layer, the first and second light absorbing layer being provided at opposite sites of the pixels. In known electrophoretic display devices a reflective electrode is employed to achieve the desired effect. In the electrophoretic display device according to the invention a reflective electrode is dispensed with. This largely simplifies the manufacturing of the display device and, in addition, reduces the risk of the build-up of an internal cell voltage. The electrophoretic display device according to the invention provides a high brightness and high contrast and, in addition, provides a true paper-like readability.

The light absorbing layer is used to avoid that light intended for one side of the display device reaches the other side of the display devices. Preferably, the light absorbing layer ( ) comprises a patterned absorbing material.

Preferably, the pixel electrodes are provided in close contact with the cells with electrophoretic medium. To this end the light absorbing layer is, preferably, provided between the pixels and the electrodes. In this manner the electrodes are provided in close contact with the cells with electrophoretic medium.

A preferred embodiment of the electrophoretic display device according to the invention is characterized in that each of the pixels is associated with a thin-film transistor

An alternatively preferred embodiment of the electrophoretic display device wherein the light absorbing layer is provided on the electrodes at a side facing away from the pixels.

A preferred embodiment of the electrophoretic display device according to the invention is characterized in that the ratio of the effective surface area Si of the first sub-pixel and the effective surface area S₂ of the second sub-pixel is in the range from 1≦S₁/S₂≦5. In many applications, a primary display direction on the inside of the closed device is supplemented by a secondary display direction on the outside of the device. The secondary display direction may be of relatively low brightness, represented by a small sub-pixel size, S₂. The primary display direction may be of a relatively high brightness, represented by a large sub-pixel size, S₁.

Preferably, the electrophoretic medium comprises micro-encapsulated electrophoretic ink. Preferably, the electrophoretic display device comprises one micro-capsule per pixel or one micro-capsule per sub-pixel. Preferably, the micro-encapsulated electrophoretic ink comprises two types of particles, the particles always staying in the optical path of the pixels.

To enable undisturbed viewing of the electrophoretic display device, the pixel electrodes are, preferably, translucent. Preferably, the pixel electrodes are made from indium tin oxide (ITO) or any other suitable transparent conduction material.

Preferably, the pixels of the electrophoretic display device array are arranged in the form of a matrix (with rows and columns).

These and other aspects of the invention are apparent from and will be elucidated with reference to the embodiments described hereinafter.

### In the drawings:

FIG. 1A shows an embodiment of an electrophoretic display device displaying in two different directions according to the invention;

FIG. 1B shows an alternative switching mode of the embodiment of the electrophoretic display device as shown in FIG. 1A;

FIG. 2A shows an alternative embodiment of an electrophoretic display device displaying in two different directions according to the invention;

FIG. 2B shows an alternative switching mode of the embodiment of the electrophoretic display device as shown in FIG. 2A;

FIGS. 3A and 3B show a personal digital assistant comprising an electrophoretic display device according to the invention, and

FIGS. 4A and 4B show a mobile telephone comprising an electrophoretic display device according to the invention.

The Figures are purely diagrammatic and not drawn to scale. Particularly for clarity, some dimensions are exaggerated strongly. Similar components in the Figures are denoted by the same reference numerals as much as possible.

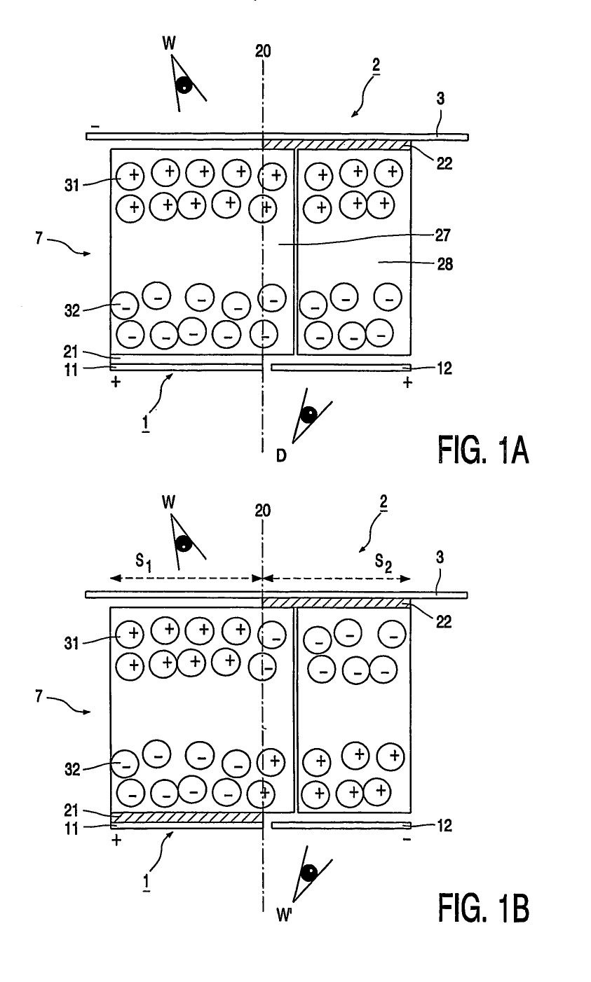

FIG. 1A very schematically shows an embodiment of an electrophoretic display device displaying in two different directions. The electrophoretic display device comprises a plurality of pixels with an electrophoretic medium 7. Each pixel is divided into a first sub-pixel 1 and a second sub-pixel 2. In addition, each pixel is provided with a (substantially transparent) common electrode 3 extending over the first sub-pixel 1 and over and the second sub-pixel 2. The first sub-pixel 1 is provided with a first (substantially transparent) sub-pixel electrode 11. The second sub-pixel 2 is provided with a (substantially transparent) second sub-pixel electrode 12. In this manner, the state of each sub-pixel 1; 2 can be set independently. Each sub-pixel 1; 2 may generate information independently of the other sub-pixel. In this manner, different information can be displayed substantially simultaneously on each side of the display device.

Preferably, the pixel electrodes are made from indium tin oxide (ITO) or any other suitable transparent conduction material. Preferably, the first and second light absorbing layer 21, 22 are provided as a patterned absorbing material.

In the example as shown in FIG. 1A the first sub-pixel 1 is provided with a first light absorbing layer 21 and the second sub-pixel 2 is provided with a second light absorbing layer 22, the first and second light absorbing layer 21; 22 being provided at opposite sites of the pixels. In addition, the light absorbing layer 21; 22 in FIG. 1A is provided between the pixels and the common electrode 3, and between the pixels and the first and second sub-pixel electrodes 11; 12. Preferably, the light absorbing layer 21, 22 is patterned.

The electrophoretic medium in the display device according to the invention, preferably, comprises micro-encapsulated electrophoretic ink 27; 28. Preferably, each pixel comprises one micro-capsule or each sub-pixel comprises one micro-capsule. In the example of FIG. 1A, the separation between the first and second sub-pixel 1; 2 is determined by the location of the first and second sub-pixel electrode 11; 12 (indicated by the dotted line 20 in FIG. 1A) and not by the separation between the micro-capsules 27; 28.

Preferably, the micro-encapsulated electrophoretic ink comprises two types of particles 31; 32, in the example of FIG. 1A positively-charged light-colored or “white” particles 31 and negatively-charged dark-colored or “black” particles 32. The particles 31; 32 may also be colored in any suitable manner.

In the embodiment of the invention as shown in FIG. 1A, the particles 31; 32 always stay in the optical path of the pixels.

FIG. 1A displays a certain switching mode of the electrophoretic display device. The common electrode 3 is provided with a negative voltage and the first and second sub-pixel electrodes 11; 12 are provided with a positive voltage. In this switching mode, the positively-charged (light-colored) particles 31 are in the vicinity of the common electrode 3. In addition, the negatively-charged (dark-colored) particles 32 are in the vicinity of the first and second sub-pixel electrodes 11; 12. A viewer looking towards the front-side (the “top-side” in FIG. 1A) of the electrophoretic display device perceives a light-colored image, indicated with a W in FIG. 1A. A viewer looking towards the back-side (the “bottom-side” in FIG. 1A) of the electrophoretic display device perceives a dark-colored image, indicated with a D in FIG. 1A. The viewing directions are schematically indicated in FIG. 1A.

FIG. 1B shows an alternative switching mode of the embodiment of the electrophoretic display device as shown in FIG. 1A. In the example of FIG. 1B the first sub-pixel electrode 11 is provided with a positive voltage and the second sub-pixel electrode 12 is provided with a negative voltage, while the common electrode 3 is provided with an intermediate voltage, for example, the common electrode 3 is grounded. In this switching mode, the positively-charged (light-colored) particles 31 in the first sub-pixel 1 are in the vicinity of the common electrode 3 while the negatively-charged (dark-colored) particles 32 in the first sub-pixel 1 are in the vicinity of the first sub-pixel electrode 11. In addition, the positively-charged (light-colored) particles 32 in the second sub-pixel 2 are in the vicinity of the second sub-pixel electrode 12 while the negatively-charged (dark-colored) particles 32 in the second sub-pixel 2 are in the vicinity of the common electrode 3. Due to the absorbing character of the first and second absorbing layer 21; 22, a viewer looking towards the front-side (the “top-side” in FIG. 1A) of the electrophoretic display device perceives a light-colored image, indicated with a W in FIG. 1B. A viewer looking towards the back-side (the “bottom-side” in FIG. 1A) of the electrophoretic display device also perceives a light-colored image, indicated with a W′ in FIG. 1B.

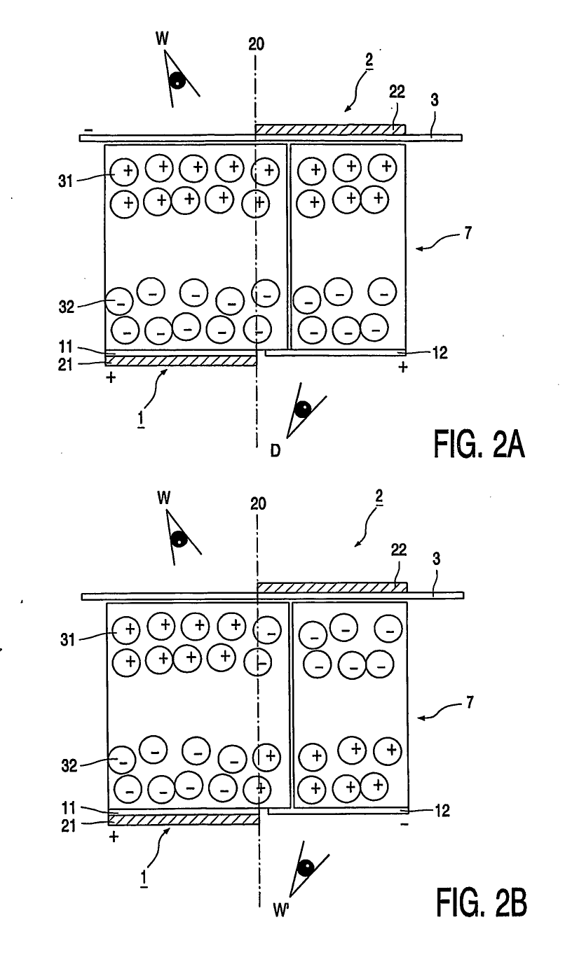

FIG. 2A shows an alternative embodiment of an electrophoretic display device displaying in two different directions according to the invention. In the example of FIG. 2A the light absorbing layer 21; 22 is provided on top of the common electrode 3 and on the first and second sub-pixel electrodes 11, 12 at a side facing away from the pixels. In this case, the voltage applied to the subpixels may be lower as there will be no voltage drop across the light absorbing layer.

FIG. 2A displays a certain switching mode of the electrophoretic display device. The common electrode 3 is provided with a negative voltage and the first and second sub-pixel electrodes 11; 12 are provided with a positive voltage. In this switching mode, the positively-charged (light-colored) particles 31 are attracted by the common electrode 3. In addition, the negatively-charged (dark-colored) particles 32 are attracted by the first and second sub-pixel electrodes 11; 12. A viewer looking at the electrophoretic display device from above in FIG. 2A perceives a light-colored image, indicated with a W in FIG. 2A. A viewer looking at the electrophoretic display device from below in FIG. 2B perceives a dark-colored image, indicated with a D in FIG. 2A. The viewing directions are schematically indicated in FIG. 1A.

FIG. 2B shows an alternative switching mode of the embodiment of the electrophoretic display device as shown in FIG. 2A. In the example of FIG. 2B the first second sub-pixel electrode 11 is provided with a positive voltage and the second sub-pixel electrode 12 is provided with a negative voltage, while the common electrode 3 is grounded. In this switching mode, the positively-charged (light-colored) particles 31 in the first sub-pixel 1 are in the vicinity of the common electrode 3 while the negatively-charged (dark-colored) particles 32 in the first sub-pixel 1 are in the vicinity of the first subpixel electrode 11. In addition, the positively-charged (light-colored) particles 32 in the second sub-pixel 2 are in the vicinity of the second sub-pixel electrode 12 while the negatively-charged (dark-colored) particles 32 in the second sub-pixel 2 are in the vicinity of the common electrode 3. Due to the absorbing character of the first and second absorbing layer 21; 22, a viewer looking at the electrophoretic display device from above perceives a light-colored image, indicated with a W in FIG. 2B. A viewer looking at the electrophoretic display from below also perceives a light-colored image, indicated with a W′ in FIG. 2B.

In a favorable embodiment of the electrophoretic display device according to the invention the ratio of the effective surface area S₁ of the first sub-pixel (1) and the effective surface area S₂ of the second sub-pixel (2) is in the range from 1≦S₁/S₂≦5. For example, in many applications using the so-called “clam shell” or “flip-phone” formats, a primary display direction on the inside of the closed device is supplemented by a secondary display direction on the outside of the device. The secondary display direction may be used simply to indicate that a new message has been received by the application, and may therefore be of relatively low brightness, represented by a small sub-pixel size, S₂. The primary display direction may be used to actually read the new message, and may therefore be of relatively high brightness, represented by a large sub-pixel size, S₁.

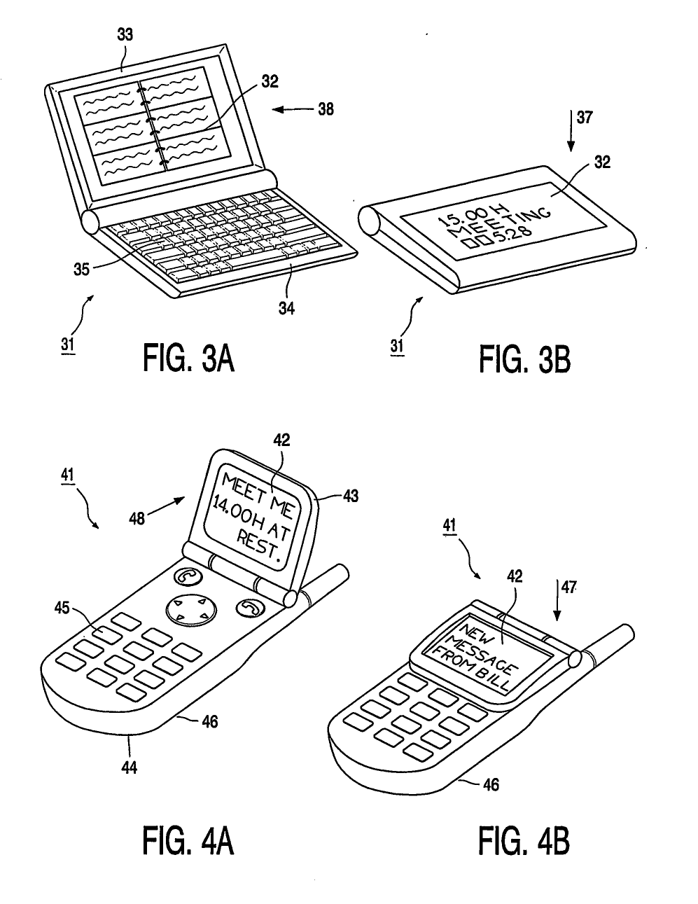

FIGS. 3A and 3B show a perspective view of a personal digital assistant comprising a electrophoretic display device according to the invention. In the example of FIGS. 3A and 3B, the personal digital assistant is a laptop computer 31 with an associated electrophoretic display device 32 in a housing 33 which is connected via a hinge to a further housing 34 accommodating further components of the laptop computer 31 such as a keyboard 35 (FIG. 3A) which is not visible in the closed state (FIG. 3B). In the closed state, a viewer sees the other side of the electrophoretic display device 32.

FIGS. 4A and 41 show a perspective view of a mobile telephone comprising an electrophoretic display device according to the invention. In the example of FIGS. 4A and 4B, the mobile telephone 41 with an associated electrophoretic display device 42 in a housing 43 which is connected via a hinge to a further housing 44 accommodating further components of the mobile telephone 41 such as a keyboard 45 (FIG. 4A) which is not visible in the closed state (FIG. 4B). In the closed state, a viewer sees the other side of the electrophoretic display device 42.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An electrophoretic display device displaying to two different directions, comprising:
a plurality of pixels with an electrophoretic medium (7),
each pixel being divided into a first and a second sub-pixel (1; 2),
each pixel being provided with a common electrode (3) extending over the first and second sub-pixel (1; 2),
the first sub-pixel (1) being provided with a first sub-pixel electrode (11) and the second sub-pixel (2) being provided with a second sub-pixel electrode (12).

2. An electrophoretic display device as claimed in claim 1, characterized in that the first sub-pixel (1) is provided with a first light absorbing layer (21) and the second sub-pixel (2) is provided with a second light absorbing layer (22), the first and second light absorbing layer (21; 22) being provided at opposite sites of the pixels.

3. An electrophoretic display device as claimed in claim 2, characterized in that the light absorbing layer (21; 22) is provided between the pixels and the electrodes (3; 11, 12).

4. An electrophoretic display device as claimed in claim 2, characterized in that the light absorbing layer (21; 22) is provided on the electrodes (3; 11, 12) at a side facing away from the pixels.

5. An electrophoretic display device as claimed in claim 2, characterized in that the light absorbing layer (21, 22) comprises a patterned absorbing material.

6. An electrophoretic display device as claimed in claim 1, characterized in that the ratio of the effective surface area S₁ of the first sub-pixel (1) and the effective surface area S₂ of the second sub-pixel (2) is in the range from 1≦S₁/S₂≦5.

7. An electrophoretic display device as claimed in claim 1, characterized in that the electrophoretic medium comprises micro-encapsulated electrophoretic ink.

8. An electrophoretic display device as claimed in claim 7 with one micro-capsule per pixel or with one micro-capsule per sub-pixel.

9. An electrophoretic display device as claimed in claim 7, characterized in that the micro-encapsulated electrophoretic ink comprises two types of particles (31; 32), the particles (31; 32) always staying in the optical path of the pixels.

10. An electrophoretic display device as claimed in claim 1, characterized in that the display device displays a first image on a side of the display device and a second image on an opposite side of the display device, the first and second image being viewable substantially simultaneously.
